(19) United States
(12) Patent Application Publication
(10) Pub. No.: US 2024/0358078 A1
(43) Pub. Date: Oct. 31, 2024

(54) HEATER

(71) Applicant: NICOVENTURES TRADING LIMITED, London (GB)

(72) Inventor: Anton Korus, Derby (GB)

(21) Appl. No.: 18/688,084

(22) PCT Filed: Aug. 30, 2022
(86) PCT No.: PCT/GB2022/052214

§ 371 Date: Feb. 29, 2024

(30) Foreign Application Priority Data
Aug. 31, 2021 (GB) 2112364.1

(51) Int. Cl. A24F 40/465; A24F 40/20; A24F 40/50

(52) U.S. Cl. CPC A24F 40/465; A24F 40/50; A24F 40/20

(57) ABSTRACT

An apparatus is described comprising a resonant circuit (having a capacitor in series with an inductor circuit, wherein the inductor circuit comprises at least one inductor, where the at least one inductor includes a lossy inductive element configured to act as a heater, wherein the resonant circuit has a resonant frequency), a pulse generating circuit for applying one or more pulses to said resonant circuit, and a control module for controlling said pulse generating circuit.

### TECHNICAL FIELD

The present specification relates to a heater arrangement, for example for use in heating an aerosolisable material as part of an aerosol provision system.

### BACKGROUND

Many heating systems are known, including systems for heating an aerosolisable material as part of an aerosol provision system. There remains a need for further developments in this field.

### SUMMARY

In a first aspect, this specification describes an apparatus comprising: a resonant circuit comprising a capacitor in series with an inductor circuit, wherein the inductor circuit comprises at least one inductor, where the at least one inductor includes a lossy inductive element configured to act as a heater, wherein the resonant circuit has a resonant frequency; a pulse generating circuit for applying one or more pulses (e.g. step pulses) to said resonant circuit; and a control module for controlling said pulse generating circuit. The lossy inductor may be configured to aerosolise a substance in a heating mode of operation. In some example embodiments, the inductor circuit comprises a first inductive element in series with said lossy inductive element.

The inductor circuit may comprises a first inductive element in parallel with said lossy inductive element. Alternatively, the inductor circuit may comprise a first inductive element in parallel with a series combination of said lossy inductive element and a third inductive element.

The lossy inductive element may have a higher AC resistance than the first inductive element at the resonant frequency of the resonant circuit.

The lossy inductive element may, for example, be formed from aluminium. Other materials, such as steel, are also possible.

The control module may be configured to control said pulse generating circuit depending on said resonant frequency.

The control module may be configured to determine said resonant frequency. In some example embodiments, the control module is configured to infer a temperature of the lossy inductive element based on the determined resonant frequency. Furthermore, the control module may be configured to control said pulse generating circuit based on the inferred temperature.

In some example embodiments, the control module is configured to control said pulse generating circuit to apply said pulses to said resonant circuit at said resonant frequency.

In some example embodiments, the pulse generating circuit includes an H-bridge driving circuit.

In a second aspect, this specification describes an aerosol provision system for generating aerosol from an aerosolisable material. The aerosol provision system of the second aspect may include any feature of the first aspect described above.

In a third aspect, this specification describes a method comprising: applying one or more pulses to a resonant circuit comprising a capacitor in series with an inductor circuit, wherein the inductor circuit comprises at least one inductor, where the at least one inductor includes a lossy inductive element configured to act as a heater, wherein the resonant circuit has a resonant frequency. The lossy inductor may be used to aerosolise a substance in a heating mode of operation.

The inductor circuit may comprises a first inductive element in series with said lossy inductive element. The inductor circuit may comprises a first inductive element in parallel with said lossy inductive element. Alternatively, the inductor circuit may comprise a first inductive element in parallel with a series combination of said lossy inductive element and a third inductive element.

The lossy inductive element may have a higher AC resistance than the first inductive element at the resonant frequency of the resonant circuit.

Some example embodiments further comprise determining said resonant frequency. Furthermore, some example embodiment comprise inferring a temperature of the lossy inductive element based on the determined resonant frequency. The application of said pulses may be based on the inferred temperature.

Some example embodiments further comprise applying said one or more pulses at said resonant frequency.

In a fourth aspect, this specification describes a computer program comprising instructions for causing an apparatus to perform at least the following: apply one or more pulses to a resonant circuit comprising a capacitor in series with an inductor circuit, wherein the inductor circuit comprises at least one inductor, where the at least one inductor includes a lossy inductive element configured to act as a heater, wherein the resonant circuit has a resonant frequency. The computer program may be further configured to perform any aspect of the method described above with reference to the third aspect. The apparatus may comprise: at least one processor; and at least one memory including said computer program.

In a fifth aspect, this specification describes a computer-readable medium (such as a non-transitory computer-readable medium) comprising program instructions stored thereon for performing (at least) any method as described with reference to the third aspect.

### BRIEF DESCRIPTION OF THE DRAWINGS

Example embodiments will now be described, by way of example only, with reference to the following schematic drawings, in which:

FIG. 1 is a block diagram of a system in accordance with an example embodiment;

FIG. 2 shows a resonant circuit in accordance with an example embodiment;

FIG. 3 is a flow chart showing an algorithm in accordance with an example embodiment;

FIGS. 4 and 5 are block diagrams of systems in accordance with example embodiments;

FIGS. 6 and 7 are block diagrams of non-combustible aerosol provision devices in accordance with example embodiments;

FIGS. 8 to 11 show resonant circuits in accordance with example embodiments;

FIG. 12 is a plot showing a pulse used in example embodiments; and

FIG. 13 is a flow chart showing an algorithm in accordance with an example embodiment.

### DETAILED DESCRIPTION

As used herein, the term “aerosol delivery device” is intended to encompass systems that deliver a substance to a user, and includes:

non-combustible aerosol provision systems that release compounds from an aerosolisable material without combusting the aerosolisable material, such as electronic cigarettes, tobacco heating products, and hybrid systems to generate aerosol using a combination of aerosolisable materials; and articles comprising aerosolisable material and configured to be used in one of these non-combustible aerosol provision systems.

According to the present disclosure, a “combustible” aerosol provision system is one where a constituent aerosolisable material of the aerosol provision system (or component thereof) is combusted or burned in order to facilitate delivery to a user.

According to the present disclosure, a “non-combustible” aerosol provision system is one where a constituent aerosolisable material of the aerosol provision system (or component thereof) is not combusted or burned in order to facilitate delivery to a user. In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolisable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolisable materials, one or a plurality of which may be heated. Each of the aerosolisable materials may be, for example, in the form of a solid, liquid or gel and may or may not contain nicotine. In one embodiment, the hybrid system comprises a liquid or gel aerosolisable material and a solid aerosolisable material. The solid aerosolisable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energised so as to distribute power in the form of heat to an aerosolisable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolisable material, an aerosol generating component, an aerosol generating area, a mouthpiece, and/or an area for receiving aerosolisable material.

In one embodiment, the aerosol generating component is a heater capable of interacting with the aerosolisable material so as to release one or more volatiles from the aerosolisable material to form an aerosol.

In one embodiment, the aerosolisable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolisable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12. In one embodiment, the active substance is a legally permissible recreational drug.

The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavours, carriers, pH regulators, stabilizers, and/or antioxidants.

In one embodiment, the article for use with the non-combustible aerosol provision device may comprise aerosolisable material or an area for receiving aerosolisable material. In one embodiment, the article for use with the non-combustible aerosol provision device may comprise a mouthpiece. The area for receiving aerosolisable material may be a storage area for storing aerosolisable material. For example, the storage area may be a reservoir. In one embodiment, the area for receiving aerosolisable material may be separate from, or combined with, an aerosol generating area.

Aerosolisable material, which also may be referred to herein as aerosol generating material, is material that is capable of generating aerosol, for example when heated, irradiated or energized in any other way. Aerosolisable material may, for example, be in the form of a solid, liquid or gel which may or may not contain nicotine and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosolisable material may be present on a substrate. The substrate may, for example, be or comprise paper, card, paperboard, cardboard, reconstituted aerosolisable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material or a material heatable by electrical conduction.

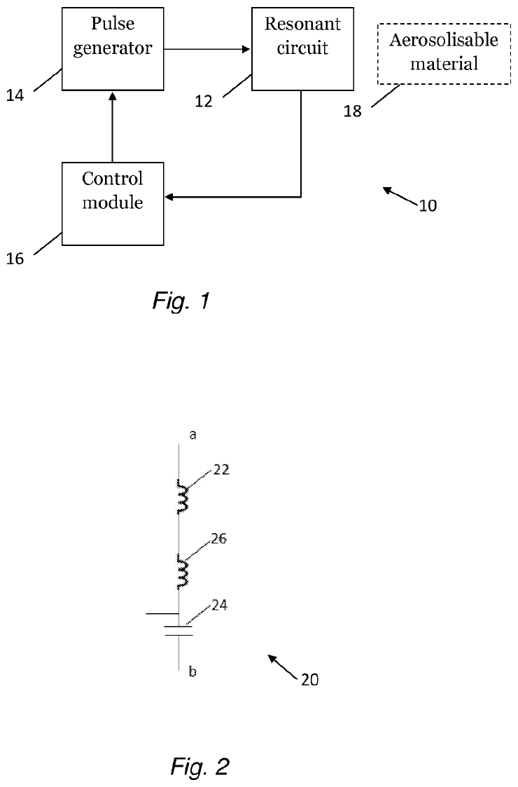

FIG. 1 is a block diagram of a system, indicated generally by the reference numeral 10, in accordance with an example embodiment.

The system 10 comprises a resonant circuit 12, a pulse generator 14 and a control module 16. The system 10 may further comprise an aerosolisable material 18.

The resonant circuit 12 has a resonant frequency. As discussed in detail below, the resonant circuit 12 comprises a capacitor in series with an inductor circuit, wherein the inductor circuit comprises at least one inductor, where the at least one inductor includes a lossy inductive element configured to act as a heater, wherein the resonant circuit has a resonant frequency.

The pulse generating circuit 14 applies one or more pulses to said resonant circuit and the control module 16 controls the pulse generating circuit (and hence the application of pulses to the resonant circuit).

As discussed in detail below, the lossy inductive element of the resonant circuit 14 may be used to heat the aerosolisable material 18. Heating the aerosolisable material may thereby generate an aerosol.

FIG. 2 shows a resonant circuit, indicated generally by the reference numeral 20, in accordance with an example embodiment. The resonant circuit 20 is an example implementation of the resonant circuit 12 described above. The resonant circuit 20 includes nodes (labelled a and b in FIG. 2). In use, pulses provided by the pulse generator 14 are provided across the nodes.

The resonant circuit 20 comprises a first inductive element 22, a first capacitor 24 and a second inductive element 26 that are connected in series. The resonant frequency of an LC circuit having multiple inductors may be expressed as:

$$\frac{1}{2 π \sqrt{( {L}_{total} ) C}}$$

In the example resonant circuit 20, if the first inductive element 22 has an inductance L₁, the first capacitor 24 has a capacitance C₁ and the second inductive element 26 has an inductance L₂, then the resonant frequency of the resonant circuit 20 is given by:

$$\frac{1}{2 π \sqrt{( {L}_{1} + {L}_{2} ) {C}_{1}}}$$

In an example use of the system 10, the second inductive element 26 is arranged to have a higher AC resistance that the first inductive element 22, such that the second inductive element 26 is the lossy inductive element described above. By pulsing the resonant circuit at its resonant frequency, the second (higher resistance) inductive element 26 acts as a heater. The second inductive element 26 has a higher AC resistance than the first inductive element 22, since, during heating, the AC resistance will dominate. In one example embodiment, the second inductive heating element is formed from aluminium, but this is not essential to all example embodiments. For example, the second inductive element could be stainless steel or any other metal able to handle the current and the temperatures involved.

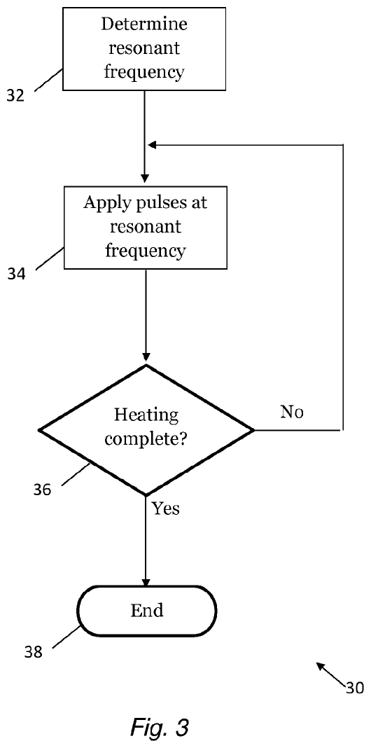

FIG. 3 is a flow chart showing an algorithm, indicated generally by the reference numeral 30, in accordance with an example embodiment. The algorithm 30 may be implemented using the system 10 described above (for example including the resonant circuit 20). The algorithm 30 may be used to control a heater (e.g. the lossy inductive element described above) to aerosolise a substance in a heating mode of operation.

The algorithm 30 starts at operation 32, where a resonant frequency of the resonant circuit 12 (e.g. the resonant circuit 20 or one of the resonant circuits described below) is determined. For example, the control module 16 may determine said resonant frequency.

At operation 34, pulses are applied to the resonant circuit at the determined resonant frequency. As discussed above, by pulsing the resonant circuit at its resonant frequency, the lossy inductive element can be used as a heater. In one example embodiment, the control module 16 is configured to control the pulse generator 14 to apply pulses to the resonant circuit 12 at the determined resonant frequency.

At operation 36, after the application of a number of pulses (e.g. a predetermined number of pulses), a determination is made regarding whether a heating process is complete. The determination in operation 36 may take many forms, such as determining whether a heating duration is complete, whether a predefined temperature has been reached or whether a defined amount of energy has been output in the form of heat.

If heating is complete, then the algorithm 30 terminates at operation 38; otherwise the algorithm returns to operation 34 such that further pulses are applied.

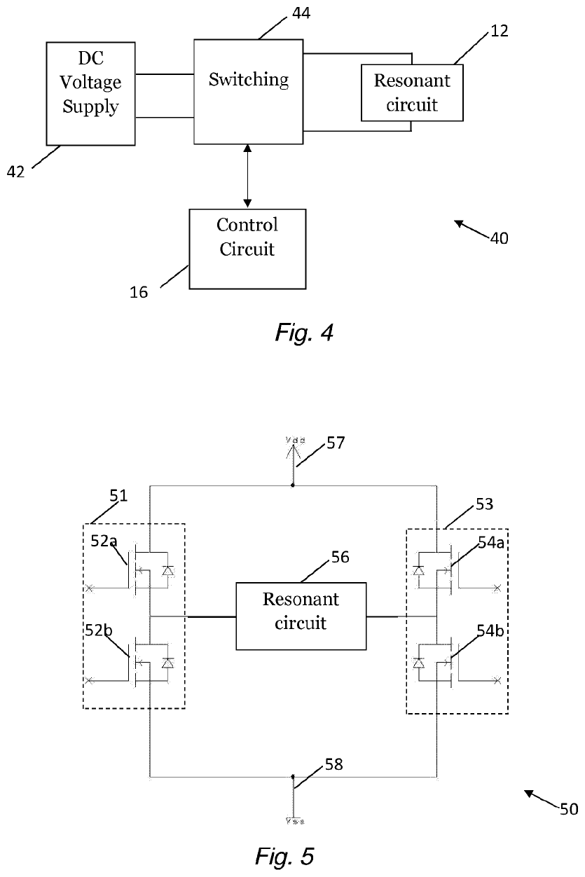

FIG. 4 is a block diagram of a system, indicated generally by the reference numeral 40, in accordance with an example embodiment. The system 40 is an example implementation of the system 10 described above.

The system 40 comprises the resonant circuit 12 and the control circuit 16 described above and additionally comprises a power source (in the form of a direct current (DC) voltage supply 42) and a switching arrangement 44 that can be used to implement the pulse generator 14 described above.

The switching arrangement 44 may enable an alternating current to be generated from the DC voltage supply 42 (under the control of the control circuit 16). The alternating current may flow through the resonant circuit 12 and may cause heating of the relevant inductor. The switching arrangement may comprise a plurality of transistors. Example DC-AC converters include H-bridge or inverter circuits, examples of which are discussed below.

FIG. 5 is a block diagram of a circuit, indicated generally by the reference numeral 50, in accordance with an example embodiment. The circuit 50 comprises a first limb 51 comprising a first switch 52a and a second switch 52b, a second limb 53 comprising a third switch 54a a fourth switch 54b and a resonant circuit 56. The first to fourth switches 51 to 54 are implemented using transistors. The resonant circuit 56 may be the resonant circuit 12 (e.g. the resonant circuit 20) described above.

The first to fourth switches 51 to 54 form an H-bridge bridge circuit that may be used to apply pulses to the resonant circuit 56. Thus, the first to fourth switches 51 to 54 are an example implementation of the switching arrangement 44 and can be used to implement the pulse generator 14.

The first switch 52a can selectively provide a connection between a first power source 57 (labelled VDD in FIG. 5) and a first connection point, the second switch 52b can selectively provide a connection between the first connection point and ground 58, the third switch 54a can selectively provide a connection between the first power source and a second connection point and the fourth switch 54b can selectively provide a connection between the second connection point and ground. The resonant circuit 56 is provided between the first and second connection points.

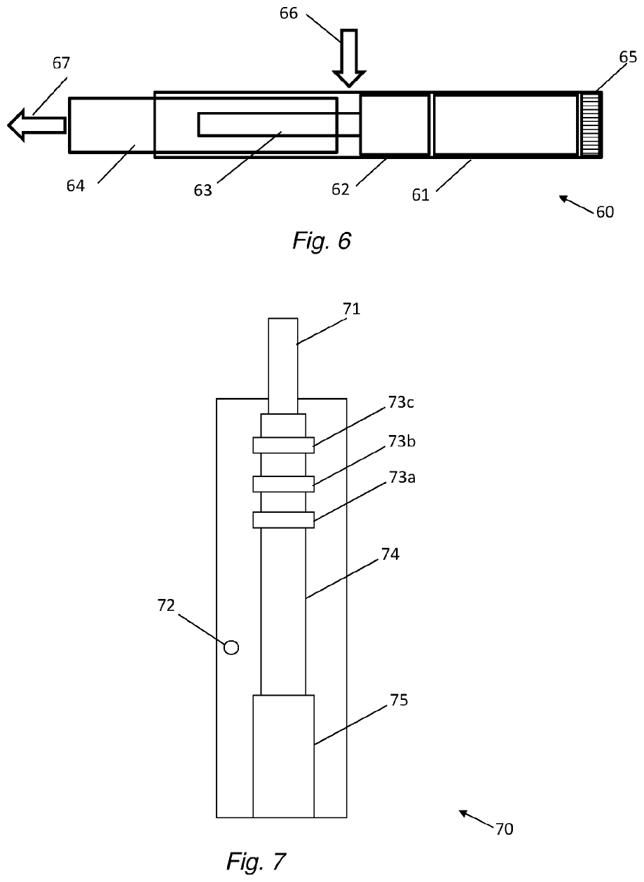

FIG. 6 is a block diagram of a non-combustible aerosol provision device, indicated generally by the reference numeral 60, in accordance with an example embodiment.

The aerosol provision device 60 comprises a battery 61, a control circuit 62, a heater 63 and a consumable 64 (e.g. a tobacco consumable, for example in the form of a tobacco stick). The device also includes a connector 65 (such as a USB connector). The connector 65 may enable connection to be made to a power source for charging the battery 61, for example under the control of the control circuit 62.

In the use of the device 60, the heater 63 is inserted into the consumable 64, such that the consumable may be heated to generate an aerosol (and tobacco flavour, in the case of a tobacco consumable) for the user. When a user inhales at the end of the consumable, as indicated by arrow 67, the air is drawn into the device 60, through an air inlet as indicated by arrow 66, then passes through the consumable, delivering the aerosol (and tobacco flavour, in the case of a tobacco consumable) to the user.

The heater 63 may comprise the lossy inductive element described above (e.g. the second inductive element 26 of the resonant circuit 20). Thus, the heating of the consumable 64 (and hence the generation of aerosol) may be controlled by the operation 30 described above. The control circuit 16 and the pulse generator 14 described above may form part of the control circuit 62.

The aerosol provision device 60 is described by way of example only. Many alternative aerosol provision devices may be used in example implementations of the principles described here. For example, the device 60 may be replaced within a vaping device in which an aerosol generating material (e.g. a liquid) is heated to generate the aerosol.

FIG. 7 is a block diagram of a non-combustible aerosol provision device, indicated generally by the reference numeral 70, in accordance with an example embodiment.

The aerosol provision device 70 may comprise a replaceable article 71 that may be inserted in the aerosol provision device 70 to enable heating thereof. The aerosol provision device 70 may further comprise an activation switch 72 that may be used for switching on or switching off the aerosol provision device 70.

The aerosol generating device 70 further comprises a plurality of lossy inductive elements 73a, 73b, and 73c acting as heaters, and one or more air tube extenders 74 and 75. The one or more air tube extenders 74 and 75 may be optional.

The plurality of lossy inductive elements 73a, 73b, and 73c may each form part of a resonant circuit, such as the resonant circuits 12 or 20 described above, or one of the resonant circuits 80 to 110 described below. The use of three inductive elements 73a, 73b and 73c is not essential to all example embodiments. Thus, the aerosol generating device 70 may comprise one or more inductive elements that can be used individually, or collectively, as heaters.

In an example embodiment, when the article 71 is inserted in aerosol generating device, the aerosol generating device 70 may be turned on due to the insertion of the article 71.

This may be due to detecting the presence of the article 71 in the aerosol generating device using an appropriate sensor (e.g., a light sensor). When the aerosol generating device 70 is turned on, the inductive elements 73 may cause the article 71 to be heated. Thus, difference zones of the article 71 may be heated differently by the inductive elements 73.

The resonant circuit 12 of the system 10 may take many different forms, including the form described above with reference to FIG. 2.

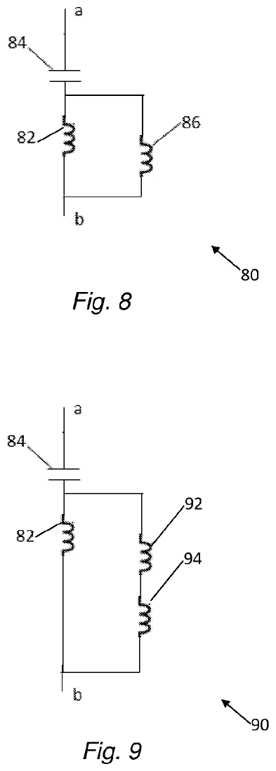

FIG. 8 shows a resonant circuit, indicated generally by the reference numeral 80, in accordance with an example embodiment. The resonant circuit 80 is an example implementation of the resonant circuit 12 described above. The resonant circuit 80 comprise a parallel connection of a first inductive element 82 and a second inductive element 86 that are connected in series with a first capacitor 84. The second inductive element 86 is a lossy inductive element having a higher AC resistance than the first inductive element 84 and may be used as a heater.

As discussed above, the resonant frequency of an LC circuit may be given by:

$$\frac{1}{2 π \sqrt{( {L}_{total} ) C}}$$

In the example resonant circuit 80, if the first inductive element 82 has an inductance L₁, the first capacitor 84 has a capacitance C₁ and the second inductive element 86 has an inductance L₂, then the resonant frequency of the resonant circuit 80 is given by:

$$\frac{1}{2 π \sqrt{( \frac{{L}_{1} {L}_{2}}{{L}_{1} + {L}_{2}} ) {C}_{1}}}$$

Many further configurations of resonant circuit may be used in alternative embodiments that may have combinations of inductors and capacitors that are more or less complicated than those described above. FIGS. 9 to 11 below describe three further examples, but the skilled person will be aware that further alternatives are possible.

FIG. 9 shows a resonant circuit, indicated generally by the reference numeral 90, in accordance with an example embodiment. The resonant circuit 90 is a variant of the resonant circuit 80 described above. The resonant circuit 90 comprise the first inductive element 82 connected in parallel with a series connection of a second inductive element 92 and a third inductive element 94. The inductive elements 82, 92, 94 are in series with the first capacitor 84. The second inductive element 92 is a lossy inductive element having a relatively high AC resistance (relative to at least the second inductive element 92) and may be used as a heater.

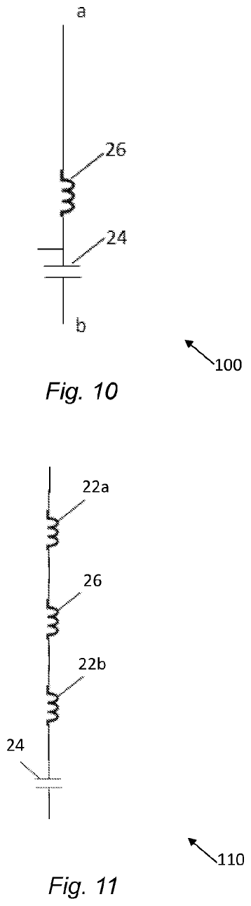

FIG. 10 shows a resonant circuit, indicated generally by the reference numeral 100, in accordance with an example embodiment. The resonant circuit 100 is a variant of the resonant circuit 20. The resonant circuit 100 is simpler, comprising a series connection of the first capacitor 24 and the second inductive element 26 (i.e. omitting the first inductive element 22). The second inductive element 26 is a lossy inductive element and may be used as a heater.

FIG. 11 shows a resonant circuit, indicated generally by the reference numeral 110, in accordance with an example embodiment. The resonant circuit 110 is a variant of the resonant circuit 20. The resonant circuit 110 comprises a series connection of the first capacitor 24 and three inductive elements. The inductive elements include the second inductive element 26 described above and include two further inductive elements 22a and 22b either side of the second inductive element 26 that collectively provide the function of the first inductive element 22 described above. As in the example embodiments described above, the second inductive element 26 is a lossy inductive element and may be used as a heater.

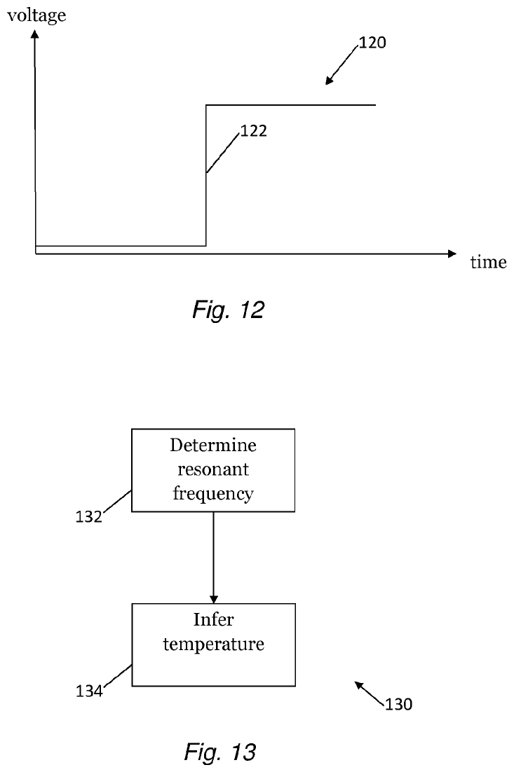

FIG. 12 is a plot showing a pulse, indicated generally by the reference numeral 120, used in example embodiments. The pulse 120 includes a rising pulse edge 122. The pulse 120 is an example of one of the pulses applied in the operation 34 of the algorithm 30.

FIG. 13 is a flow chart showing an algorithm, indicated generally by the reference numeral 130, in accordance with an example embodiment. The algorithm 130 may be implemented using the system 10 or the system 40 described above (for example including one of the resonant circuits 20, 80, 90, 100 or 110 described above). The algorithm 130 may be used to control a heater (e.g. one of the lossy inductive elements described above) to aerosolise a substance in a heating mode of operation.

The algorithm 130 starts at operation 132, where a resonant frequency of a resonant circuit (e.g. one of the resonant circuits 20, 80, 90, 100 or 110 described above or one of the resonant circuits described below) is determined. For example, the control module 16 described above may determine said resonant frequency.

Next, at operation 134 of the algorithm 130, an operation temperature (e.g. of the lossy inductive element) is inferred from the resonant frequency. This is possible if the resonant frequency is temperature dependent.

The inferred temperature may, for example, be used in the operation 36 of the algorithm 30 described above to determine whether a heating operation is complete.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An apparatus comprising:
a resonant circuit comprising a capacitor in series with an inductor circuit, wherein the inductor circuit comprises at least one inductor, where the at least one inductor includes a lossy inductive element configured to act as a heater, wherein the resonant circuit has a resonant frequency;
a pulse generating circuit for applying one or more pulses to said resonant circuit; and
a control module for controlling said pulse generating circuit.

2. The apparatus of claim 1, wherein said lossy inductor is configured to aerosolise a substance in a heating mode of operation.

3. The apparatus of claim 1, wherein the inductor circuit comprises a first inductive element in series with said lossy inductive element.

4. The apparatus of claim 1, wherein the inductor circuit comprises a first inductive element in parallel with said lossy inductive element.

5. The apparatus of claim 1, wherein the inductor circuit comprises a first inductive element in parallel with a series combination of said lossy inductive element and a third inductive element.

6. The apparatus of claim 3, wherein the lossy inductive element has a higher AC resistance than the first inductive element at the resonant frequency of the resonant circuit.

7. The apparatus of claim 1, wherein the lossy inductive element is formed from aluminium.

8. The apparatus of claim 1, wherein the control module is configured to control said pulse generating circuit depending on said resonant frequency.

9. The apparatus of claim 1, wherein the control module is configured to determine said resonant frequency.

10. The apparatus of claim 9, wherein the control module is configured to infer a temperature of the lossy inductive element based on the determined resonant frequency.

11. The apparatus of claim 10, wherein the control module is configured to control said pulse generating circuit based on the inferred temperature.

12. The apparatus of claim 1, wherein the control module is configured to control said pulse generating circuit to apply said pulses to said resonant circuit at said resonant frequency.

13. The apparatus of claim 1, wherein said one or more pulses are step pulses.

14. The apparatus of claim 1, wherein said pulse generating circuit includes an H-bridge driving circuit.

15. An aerosol provision system for generating aerosol from an aerosolisable material, the aerosol provision system comprising the apparatus of claim 1.

16. A method comprising:
applying one or more pulses to a resonant circuit comprising a capacitor in series with an inductor circuit, wherein the inductor circuit comprises at least one inductor, where the at least one inductor includes a lossy inductive element configured to act as a heater, wherein the resonant circuit has a resonant frequency.

17. A method as claimed in claim 16, wherein the inductor circuit comprises one of:
a first inductive element in series with said lossy inductive element;
a first inductive element in parallel with said lossy inductive element; and
a first inductive element in parallel with a series combination of said lossy inductive element and a third inductive element.

18. The method of claim 16, wherein the lossy inductive element has a higher AC resistance than the first inductive element at the resonant frequency of the resonant circuit.

19. The method of claim 16, further comprising determining said resonant frequency.

20. A The method of claim 19, further comprising inferring a temperature of the lossy inductive element based on the determined resonant frequency.

21. The method of claim 20, further comprising controlling the application of said pulses based on the inferred temperature.

22. The method of claim 16, further comprising applying said one or more pulses at said resonant frequency.

23. A computer program comprising instructions for causing an apparatus to perform at least the following:
apply one or more pulses to a resonant circuit comprising a capacitor in series with an inductor circuit, wherein the inductor circuit comprises at least one inductor, where the at least one inductor includes a lossy inductive element configured to act as a heater, wherein the resonant circuit has a resonant frequency.
